(19) United States
(12) Patent Application Publication
(10) Pub. No.: US 2020/0343650 A1
(43) Pub. Date: Oct. 29, 2020

(54) SHIELD CONNECTOR

(71) Applicant: Yazaki Corporation, Tokyo (JP)

(72) Inventors: Shinji SHIRAISHI, Susono-shi (JP); Shingo OKADA, Susono-shi (JP)

(73) Assignee: Yazaki Corporation, Tokyo (JP)

(21) Appl. No.: 16/848,045

(22) Filed: Apr. 14, 2020

(30) Foreign Application Priority Data
Apr. 26, 2019 (JP) 2019-085847

(51) Int. Cl. H01R 4/18; H01B 7/18

(52) U.S. Cl. CPC H01R 4/183; H01B 7/181

(57) ABSTRACT

An object of the present invention is to provide a shield connector that suppresses deterioration of shield performance even when temperature changes are repeated. The shield connector includes a cylindrical braided conductor sheathed on an electric wire, a shield shell having a cylindrical portion covered by the braided conductor, and a shield ring that is crimped so that the braided conductor is positioned between the cylindrical portion and the shield ring. The braided conductor is provided in a state where an adhesive body is soaked. The adhesive body soaked in the braided conductor is adhered between the braided conductor and the cylindrical portion and between the braided conductor and the shield ring.

### TECHNICAL FIELD

The present invention relates to a shield connector.

### BACKGROUND ART

A wide variety of electronic devices are mounted on automobiles, and wire harnesses (W/H) are routed to transmit electric power, control signals, and the like to these electronic devices. The wire harness includes a plurality of electric wires and a connector, and is connected to the electronic devices or another wire harness by fitting the connector to a connector of the electronic devices or another wire harness.

As a connector used for such a wire harness, a shield connector attached to the terminals of two shielded cables that handle a high voltage of such as an electric vehicle (EV) or a hybrid electric vehicle (HEV) is known (for example, refer to Patent Literature 1).

The conventional shield connector disclosed in Patent Literature 1 includes a terminal-attached electric wire with a terminal connected to the end of the electric wire; a housing to accommodate terminals of electric wires with terminals; a shield shell assembled to the housing; a braided conductor sheathed on the electric wire; and a shield ring that is clamped so that a braided conductor is sandwiched between the shield shell and the shield ring that can be electrically connected. That is, in the conventional shield connector, the braided conductor is electrically connected to the shield shell by sandwiching the braided conductor between the shield ring and the shield shell and crimping using the shield ring.

### PRIOR ART DOCUMENT

### Patent Literature

Patent Literature 1: JP 2010-268562 A

### SUMMARY OF INVENTION

### Technical Problem

In the conventional shield connector, when the thermal expansion coefficients of the shield shell and the shield ring are different, the shield performance may be deteriorated by repeatedly changing the temperature between high and low temperatures.

An object of the present invention is to provide a shield connector that suppresses deterioration of shield performance even when temperature changes are repeated.

### Solution to Problem

In order to solve the problem and achieve the object, according to a first aspect of the present invention, there is provided a shield connector comprising:

a cylindrical braided conductor sheathed on an electric wire;

a shield shell having a cylindrical portion covered by the braided conductor; and

a shield ring that is crimped so that the braided conductor is positioned between the cylindrical portion and the shield ring

wherein the braided conductor is provided in a state where an adhesive body is soaked, and

wherein the adhesive body soaked in the braided conductor is adhered between the braided conductor and the cylindrical portion and between the braided conductor and the shield ring.

According to a second aspect of the present invention, there is provided the shield connector in the first aspect, wherein the adhesive body is provided on an entire circumference of the braided conductor.

According to a third aspect of the present invention, there is provided the shield connector in the first or second aspect, wherein the adhesive body includes at least any one of a cyanoacrylate adhesive and an ethyl α-cyanoacrylate acrylic ester adhesive.

### Effect of the Invention

According to the first aspect of the present invention, the adhesive body soaked in the braided conductor is adhered between the braided conductor and the cylindrical portion and between the braided conductor and the shield ring. Here, when the thermal expansion coefficients of the shield shell and the shield ring are different, when the temperature of the shield connector is repeated between high and low temperatures (hereinafter referred to as “temperature change”), the tightening force of the shield ring is weakened and the shield performance may be reduced. In the present invention, because between the braided conductor and the cylindrical portion, and between the braided conductor and the shield ring are bonded by an adhesive, even when the thermal expansion coefficients of the shield shell and the shield ring are different, the change in the tightening force due to the repeated temperature change is reduced, and the deterioration of the shield performance can be suppressed.

An object of the present invention is to provide a shield connector that suppresses deterioration of shield performance even when temperature changes are repeated.

### BRIEF DESCRIPTION OF DRAWINGS

FIG. 1 is a perspective view showing a collective shield W/H including a shield connector according to an embodiment of the present invention;

FIG. 2 is an exploded perspective view of the collective shield W/H;

FIG. 3 is a conceptual diagram showing a shield characteristic measuring instrument;

FIG. 4 is a diagram showing measured values of noise when a predetermined temperature change is repeated and measured values of noise when a predetermined temperature change is not repeated using a collective shield W/H without an adhesive body; and

FIG. 5 shows measured values of noise when a predetermined temperature change is repeated using a collective shield W/H without an adhesive as a comparative example, and using a collective shield W/H with an adhesive as the product of the present invention.

### DESCRIPTION OF EMBODIMENTS

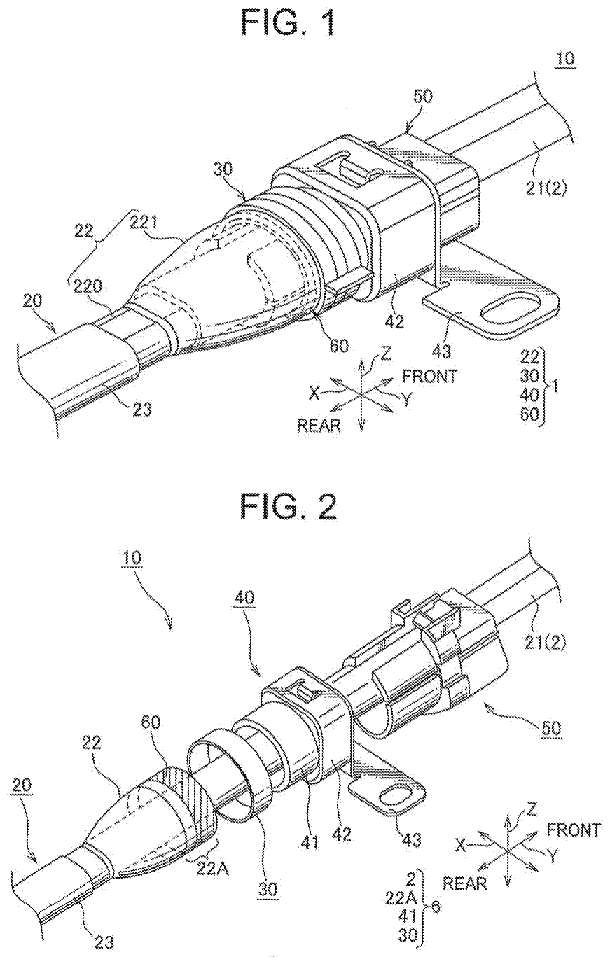

Hereinafter, embodiments of the present invention will be described with reference to the drawings. FIG. 1 is a perspective view showing a collective shield W/H 10 including a shield connector 1 according to an embodiment of the present invention. The collective shield W/H 10 is routed to an automobile or the like, and configured in a shield circuit that shields electrical noise leaking outside from shielded wire 20 that transmits control signals and the like, or electrical noise flowing from outside.

As shown in FIGS. 1 and 2, the collective shield W/H 10 includes a shielded electric wire 20, a shield ring 30, a shield shell 40, and an inner holder 50. In the collective shield W/H10, an adhesive body 60 soaks into the entire circumference of the braided conductor 22 of the shielded electric wire 20, so that between the braided conductor 22 and the small diameter portion 41 (cylindrical portion shown in FIG. 2) of the shield shell 40, and between the braided conductor 22 and the shield ring 30 are bonded. The adhesive body 60 is obtained by curing a cyanoacrylate adhesive (provided with reference numeral 60). An example of the adhesive body 60 is Aron Alpha (registered trademark) EXTRA4000 series manufactured by Toa Gosei Co., Ltd. The braided conductor 22 which will be described later of the shield wire 20, the shield ring 30, the shield shell 40, and the adhesive body 60 constitute the shield connector 1.

The shielded electric wire 20 includes a core wire (not shown) at the center, an insulating coating 21 formed of an insulating material such as an insulating resin that covers the outer periphery of the core wire, a braided conductor 22 that sheathes the insulating coating 21, and an insulating sheath 23 covering the braided conductor 22. The shielded electric wire 20 of the present embodiment has a configuration in which two cores are collectively shielded, but may be a single core or a configuration in which three or more core wires are collectively shielded. Hereinafter, the core wire and the insulation coating 21 may be referred to as “electric wire portion 2”.

The braided conductor 22 is formed, for example, by knitting fine wires (elementary wires) made of a conductive metal material or the like into a mesh shape. As shown in FIGS. 1 and 2, the braided conductor 22 is configured by having a cylindrical braided main body 220 and an enlarged diameter portion 221 provided on one side (front side) of the braided body 220 in the axial direction (arrow Y) and covering a cylindrical portion described later of the shield shell 40. At the front end of the enlarged diameter portion 221, a folded portion 22A is formed that is folded inward or outward by a predetermined dimension. In the present embodiment, the folded portion 22A is formed at the front end of the enlarged diameter portion 221, but the present invention is not limited to this. The folded portion 22A may not be provided at the front end of the enlarged diameter portion 221.

In the following, the direction in which the pair of electric wires 2 and 2 are arranged may be indicated by “arrow X”, the axial direction of each electric wire may be indicated by “arrow Y”, and the direction orthogonal to arrow X and arrow Y may be indicated by “arrow Z”. In addition, in the arrow Y, the side of the braided conductor 22 on which the enlarged diameter portion 221 is provided with respect to the braided body 220 may be referred to as “front”, and the opposite side may be referred to as “rear”.

The shield ring 30 is formed in a ring shape from a material containing iron. The folded portion 22A of the braided conductor 22 is located between the shield ring 30 and a small diameter portion 41 (described later) of the shield shell 40.

The shield shell 40 is made of a material containing aluminum, and has a hollow cylindrical small-diameter portion 41 (cylindrical portion), a main body portion 42 that is continuous in front of the small diameter portion 41 and accommodates the inner holder 50 therein and a support piece 43 provided so as to protrude from the main body portion 42 in the X direction. In the inside of the small diameter portion 41, the electric wire portion 2 of the shielded electric wire 20 is penetrated. Further, the outer peripheral surface of the small diameter portion 41 is covered with the folded portion 22A of the braided conductor 22. The front end of the main body portion 42 is opened so that the inner holder 50 can be inserted.

The inner holder 50 is provided between the electric wire portion 2 of the shielded electric wire 20 and the main body portion 42 of the shield shell 40, and prevents the liquid from entering the inside from between the electric wire portion 2 and the main body portion 42 of the shield shell 40 while supporting the electric wire portion 2.

Next, an assembly procedure of the collective shield W/H10 will be described. First, the sheath 23 is cut by a predetermined length from the front end of the shielded wire 20 to expose the braided conductor 22. Further, the braided conductor 22 is peeled off from the insulating coating 21, and the front end portion is enlarged in a taper shape to form the enlarged diameter portion 221, while the folded portion 22A is formed at the front end portion of the enlarged diameter portion 221.

Thereafter, the front end of the electric wire portion 2 is passed in the order of the small diameter portion 41 of the shield shell 40, the main body portion 42, and the inner holder 50. The folded portion 22A of the braided conductor 22 is positioned between the small diameter portion 41 and the shield ring 30 so as to cover the outer peripheral portion of the small diameter portion 41 of the shield shell 40. The shield ring 30 is crimped using a crimping die (not shown). The crimped portions are arranged radially outward in the order of the electric wire portion 2, the small diameter portion 41 of the shield shell 40, the folded portion 22A of the braided conductor 22, and the shield ring 30. Hereinafter, as illustrated in FIG. 2, the portion where the electric wire portion 2, the small diameter portion 41 of the shield shell 40, the folded portion 22A of the braided conductor 22, and the shield ring 30 are overlapped may be referred to as “overlapping portion 6”. Thereafter, the inner holder 50 is inserted into the main body portion 42 of the shield shell 40 and the inner holder 50 is attached to the main body portion 42 of the shield shell 40.

Finally, the adhesive 60 is soaked in the entire circumference of the braided conductor 22. Thereafter, the adhesive 60 is cured between the braided conductor 22 and the small diameter portion 41 of the shield shell 40 and between the braided conductor 22 and the shield ring 30 to form an adhesive body 60, and bonds the shield shell 40 and the shield ring 30 together. Thereby, the collective shield W/H 10 is completed.

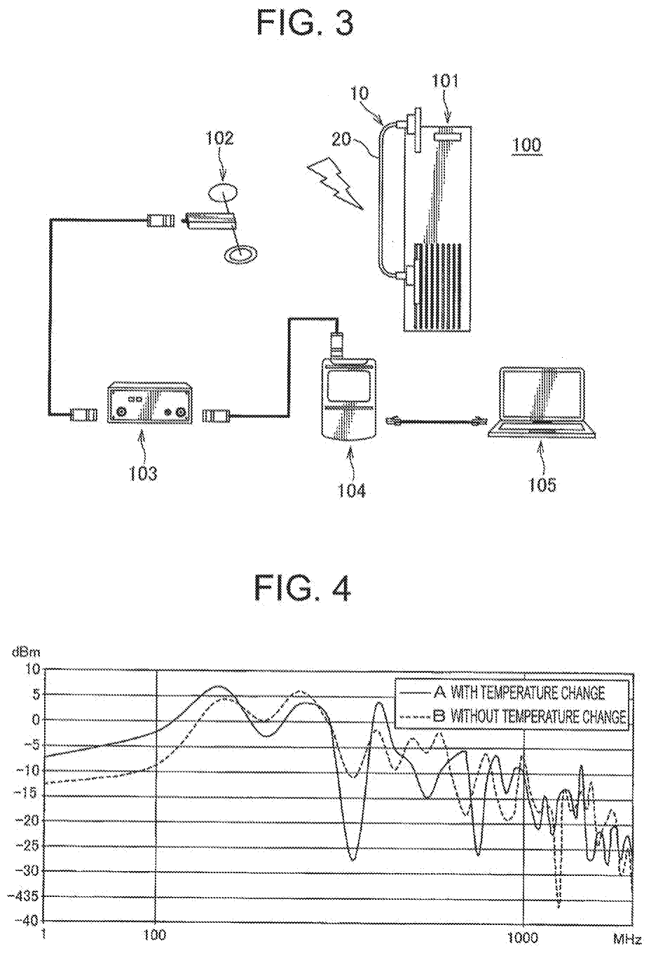

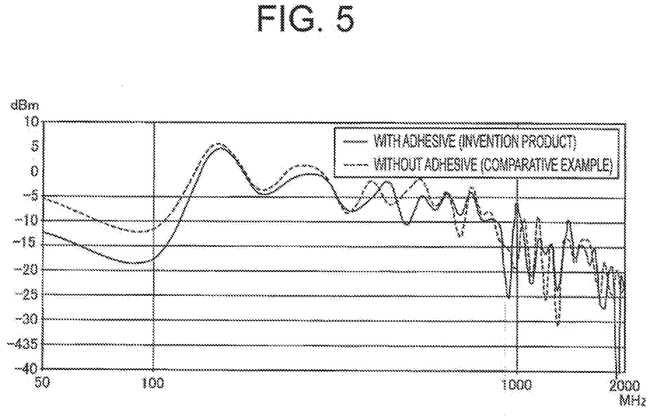

In such a collective shield W/H 10, as shown in FIG. 3, the noise radiated from the overlapping portion 6 is measured using the shield characteristic measuring instrument 100 in the following procedure. First, the signal output unit 101 applies a signal to the electric wire portion 2. The antenna unit 102 receives noise radiated to the outside of the electric wire portion 2. The radiated noise is amplified by the amplifier unit 103, converted into a digital signal by the A/D converter 104, and data processed by the data processing unit 105. The processing results are shown in FIGS. 4 and 5.

In FIG. 4, with using a collective shield W/H 10 without an adhesive as a conventional example, (A) shows the measured value of the noise of the collective shield W/H 10 which repeated a predetermined temperature change, and (B) shows the measured value of the noise of the collective shield W/H 10 which has not repeated the predetermined temperature change. Here, the predetermined temperature change means that the surface temperature of the shield ring 30 is heated to 80 degrees, then cooled to 25.5 degrees, and heated again to 120 degrees, and cooled to 27.5 degrees which is the same as the ambient temperature. According to FIG. 4, the noise increases by 2.8 dBm when the frequency is 150 MHz, and increases by 4.4 dBm when the frequency is 400 MHz. Thereby, in collective shield W/H 10 without the adhesive body, since the collective shield W/H 10 without an adhesive that repeats a predetermined temperature change (A) has an increased peak noise compared to the collective shield W/H 10 without an adhesive that does not repeat the predetermined temperature change (B), it was found that the shield performance deteriorates. That is, FIG. 4 shows that the shield performance of the collective shield W/H 10 as the conventional example changes before and after the change of the ambient environment temperature occurs. In the collective shield W/H 10 as the conventional example, the shield performance deteriorates due to the repeated high and low ambient environment temperatures due to the difference in thermal expansion coefficient between the shield ring 30 and the shield shell 40.

FIG. 5 shows measured values of noise when a predetermined temperature change is repeated using a collective shield W/H 10 without an adhesive as a comparative example, and using a collective shield W/H 10 with the adhesive body 60 as a product of the present invention. Here, the predetermined temperature change means that the surface temperature of the shield ring 30 is heated to 80 degrees, then cooled to 22.7 degrees, and heated again to 122.1 degrees, and cooled to 26.4 degrees which is the same as the ambient temperature. According to FIG. 5, the measured value of the product of the present invention does not exceed the measured value of the comparative example that does not repeat the predetermined temperature change in a specific frequency band. As compared with the comparative example, it has been clarified that the product of the present invention can suppress the deterioration of the shield performance even when the predetermined temperature change is repeated. According to FIGS. 4 and 5, the noise peak value of the collective shield W/H 10 with the adhesive body 60 as the product of the present invention is lower than each peak value of the comparative example and the conventional example even if a predetermined temperature change is repeated in a specific frequency band (150 MHz or less). In this way, it has been clarified that the product of the present invention suppresses the deterioration of the shield performance when a predetermined temperature change is repeated as compared with the conventional example and the comparative example.

According to the above-described embodiment, the adhesive body 60 soaked in the braided conductor 22 adheres between the braided conductor 22 and the small diameter portion 41 (cylindrical portion) and between the braided conductor 22 and the shield ring 30. Here, when the thermal expansion coefficients of the shield shell 40 and the shield ring 30 are different, if the temperature of the overlapping portion 6 repeats the temperature change, the tightening force of the shield ring 30 is weakened and the shield performance is deteriorated. However, the shield shell 40, the shield ring 30, and the braided conductor 22 are integrally bonded by the adhesive body 60 between the braided conductor 22 and the cylindrical portion and between the braided conductor 22 and the shield ring 30. Thereby, even when the thermal expansion coefficients of the shield shell 40 and the shield ring 30 are different, the change in the tightening force due to the repeated temperature change is reduced, and the deterioration of the shield performance can be suppressed.

Further, the adhesive body 60 is provided on the entire circumference of the braided conductor 22. Thereby, the deterioration of shield performance can be further suppressed.

Incidentally, in the above-described embodiment, after the shield ring 30 is crimped using a crimping die, the adhesive body 60 is soaked into the braided conductor 22, but the present invention is not limited to this. Prior to crimping the shield ring 30, the adhesive body 60 may be soaked into the braided conductor 22. In this case, it is preferable to use an adhesive having a relatively long curing time. That is, the adhesive may be used after the shield ring 30 is crimped or before the shield ring 30 is crimped. It is only necessary that the shield shell 40, the shield ring 30, and the braided conductor 22 are integrally bonded by the adhesive body 60 in a state where the collective shield W/H 10 is completed.

Moreover, in the above-described embodiment, although the shield shell 40 is made of the material containing aluminum, this invention is not limited to this. The shield shell 40 may be made of a material including an Invar alloy having a smaller thermal expansion coefficient than aluminum. In this way, even if the temperature change is repeated, the change in the tightening force is further reduced, and the deterioration of the shield performance can be further suppressed.

Further, in the above-described embodiment, the adhesive body 60 is soaked into the entire circumference of the braided conductor 22, but the present invention is not limited to this. The adhesive body 60 may be soaked into at least a part of the braided conductor 22 in the circumferential direction. In this way, although the shield performance is inferior compared with the case where the adhesive body 60 is soaked in the entire circumference of the braided conductor 22, it is possible to suppress the deterioration of the shield performance against the temperature change.

Further, in the above-described embodiment, the adhesive body 60 is configured to include a cyanoacrylate adhesive, but the present invention is not limited to this. The adhesive body 60 may be configured to include an ethyl α-cyanoacrylate acrylic ester adhesive, and may include both a cyanoacrylate adhesive and an ethyl α-cyanoacrylate acrylic ester adhesive. In this way, the deterioration of shield performance can be further suppressed by appropriately changing the adhesive body 60 according to the use environment.

In addition, the best configuration, method and the like for carrying out the present invention have been disclosed in the above description, but the present invention is not limited to this. That is, the present invention has been illustrated and described primarily with respect to particular embodiments, but without departing from the scope of the technical idea and object of the present invention, those skilled in the art can make various modifications to the above-described embodiments in terms of shape, material, quantity, and other detailed configurations. Therefore, the description limited to the shape, material, etc. disclosed above is exemplary for easy understanding of the present invention, and does not limit the present invention. Therefore, the description of the names of members excluding some or all of the limitations on the shape, material and the like is included in the present invention.

### REFERENCE SIGNS LIST

1 shield connector
2 electric wire portion (electric wire)
22 braided conductor
30 shield ring
40 shield shell
41 small diameter portion (cylindrical portion)
60 adhesive body

1. A shield connector comprising:
a cylindrical braided conductor sheathed on an electric wire;
a shield shell having a cylindrical portion covered by the braided conductor; and
a shield ring that is crimped so that the braided conductor is positioned between the cylindrical portion and the shield ring
wherein the braided conductor is provided in a state where an adhesive body is soaked, and
wherein the adhesive body soaked in the braided conductor is adhered between the braided conductor and the cylindrical portion and between the braided conductor and the shield ring.

2. The shield connector as claimed in claim 1,
wherein the adhesive body is provided on an entire circumference of the braided conductor.

3. The shield connector as claimed in claim 1,
wherein the adhesive body includes at least any one of a cyanoacrylate adhesive and an ethyl α-cyanoacrylate acrylic ester adhesive.

4. The shield connector as claimed in claim 2,
wherein the adhesive body includes at least any one of a cyanoacrylate adhesive and an ethyl α-cyanoacrylate acrylic ester adhesive.
